(19) United States
(12) Patent Application Publication
(10) Pub. No.: US 2007/0109674 A1
(43) Pub. Date: May 17, 2007

(54) Extendable Side View Mirror

(76) Inventor: Jim Christopher Hastie, Costa Mesa, CA (US)

Correspondence Address: FARSHAD JASON FARHADIAN;CENTURY IP LAW GROUP, P.O. BOX 7333, NEWPORT BEACH, CA, 92658-7333, US

(21) Appl. No.: 11/554,488

(22) Filed: Oct. 30, 2006

Related U.S. Application Data
(60) Provisional application No. 60/731,157, filed on Oct. 28, 2005.

(51) Int. Cl. G02B 5/08; G02B 7/18

(52) U.S. Cl. 359/841

(57) ABSTRACT

An extendable side view mirror in accordance with the preferred embodiment of the invention is provided. The extendable side view mirror comprises a mirror body configured to hold a mirror; an extendable arm having first and second terminal ends opposite each other, wherein the mirror body is coupled to the first terminal end; and a connector assembly coupled to the second terminal end. The connector assembly is configured for attachment to body of a vehicle, wherein the mirror body may be moved toward and away from the body of the vehicle when force is applied in first and second directions to the mirror body, and wherein the extendable arm respectively collapses and extends in response to the application of force.

Pursuant to 35 U.S.C. § 119(e)(1), this application claims the benefit of earlier filing date and right of priority to Provisional Application No. 60/731,157 filed on Oct. 28, 2005, entitled “Extendable Side View Mirror” the content of which is hereby incorporated by reference herein in its entirety.

### COPYRIGHT & TRADEMARK NOTICE

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or limit the scope of this invention to material associated only with such marks.

### FIELD OF THE INVENTION

The present invention relates in general to a side view mirror, and more particularly to an extendable side view mirror.

### BACKGROUND

Most original equipment manufactured (OEM) side view mirrors for vehicles are not designed for towing use. That is why replacement towing mirrors are available to allow the driver a better view of the rear of the vehicle and the road.

Typically, towing mirrors have a longer arm than the OEM mirrors so that the mirror is positioned further from the body of the vehicle to provide a broader viewing perspective and angle. Unfortunately, replacement towing mirrors are typically unattractive and do not match the body of the vehicle or the original shape of the OEM mirror.

Further, because the mirror arm is longer than the OEM mirror, it can cause undesirable results by catching onto objects that normally would not be within the reach of the OEM mirror, thereby either damaging the objects or the mirror itself. As such, some users have to assemble and disassemble the mirror depending on their towing needs or schedule. This is inconvenient.

A solution to the above problems is needed.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, an extendable mirror assembly is provided. The mirror assembly comprises a mirror body configured to hold a mirror; an extendable arm having first and second terminal ends, wherein the mirror body is coupled to the first terminal end; and a connector assembly is coupled to the second terminal end, such that the connector assembly is configured for attachment to body of a vehicle.

The mirror body may be moved toward or away from the body of the vehicle when force is applied in a first or a second direction to the mirror body. Accordingly, the extendable arm may respectively collapse or extend in response to the application of force. The extendable towing mirror preferably matches the OEM mirror for a vehicle and can telescopically extend or collapse, either manually or automatically.

Advantageously, the extendable mirror of the present invention has a simple constructional design and assembly requirements. One or more embodiments of the mirror are configured so that in a collapsed position, the mirror resembles an OEM mirror and in an extended position it allows a driver a less obstructed view of the rear of the vehicle with a tow attached.

In accordance with one aspect of the invention, an extendable mirror assembly comprises a mirror body configured to hold a mirror; an extendable arm having opposing first and second terminal ends, wherein the mirror body is coupled to the first terminal end; and a connector assembly coupled to the second terminal end, the connector assembly configured for attachment to body of a vehicle.

In one embodiment, the mirror body may be moved toward and away from the connector assembly by way of the extendible arm when force is applied in first and second directions to the mirror body, and wherein the extendable arm respectively collapses and extends in response to the application of force. The extendable arm is preferably locked in at least one position as the mirror body moves in relation to the connector assembly.

In another embodiment, the extendable arm comprises a first portion comprising a first elongated arm; and a second portion comprising a second elongated arm in a sliding relationship with the first elongated arm, such that the first portion engages the second portion in first and second locking positions when the first and second portions slide in relation to one another.

In the first and the second locking positions, the first portion disengages from the second portion in response to application of force beyond a predetermined threshold. The first portion comprises a spring-loaded hook for engaging a cavity formed on the second portion. When the spring-loaded hook engages the cavity, the first portion is locked to the second portion such that the extendable arm can no longer extend or collapse.

When the spring-loaded hook disengages from the cavity, the first portion is unlocked from the second portion such that the extendable arm can continue to extend or collapse. In the first locking position the mirror body is a first distance away from the connector assembly. In the second locking position the mirror body is a second distance away from the connector assembly. The second distance is larger than the first distance.

These and other embodiments of the present invention will become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates exemplary side view mirror assemblies as attached to a vehicle, according to one or more embodiments.

FIGS. 2 and 3 illustrate a side view mirror in various extended positions, in accordance with one or more embodiments.

FIGS. 4-6 illustrate perspective views of a side view mirror in various extended positions, in accordance with one or more embodiments.

FIG. 7 illustrates a front elevation view of a side view mirror in a fully extended position, in accordance with one embodiment.

FIG. 8 illustrates a rear elevation view of the side view mirror, in accordance with another exemplary embodiment.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

In the following description of embodiments, reference is made to the accompanying drawings that form a part hereof, and in which are shown by way of illustration various embodiment in which the invention may be practiced. It is to be understood that other embodiments may be utilized and structural changes may be made without departing from the scope of the present invention.

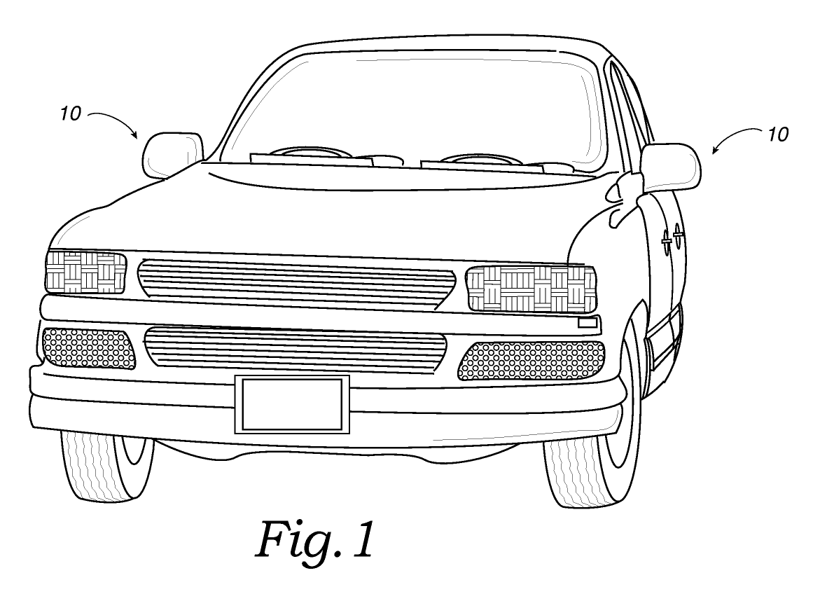

Referring to FIG. 1, in accordance to one embodiment, a side rear view mirror 10 is provided. It should be noted that while the following description is provided with reference to a side rear view mirror 10 by way of example, the principals and advantages disclosed here may be equally applicable to other mirror assemblies for attachment to any type of vehicle (e.g., cars, motorcycles, boats, planes, etc.), whether as a side view, rear view, or other type of mirror.

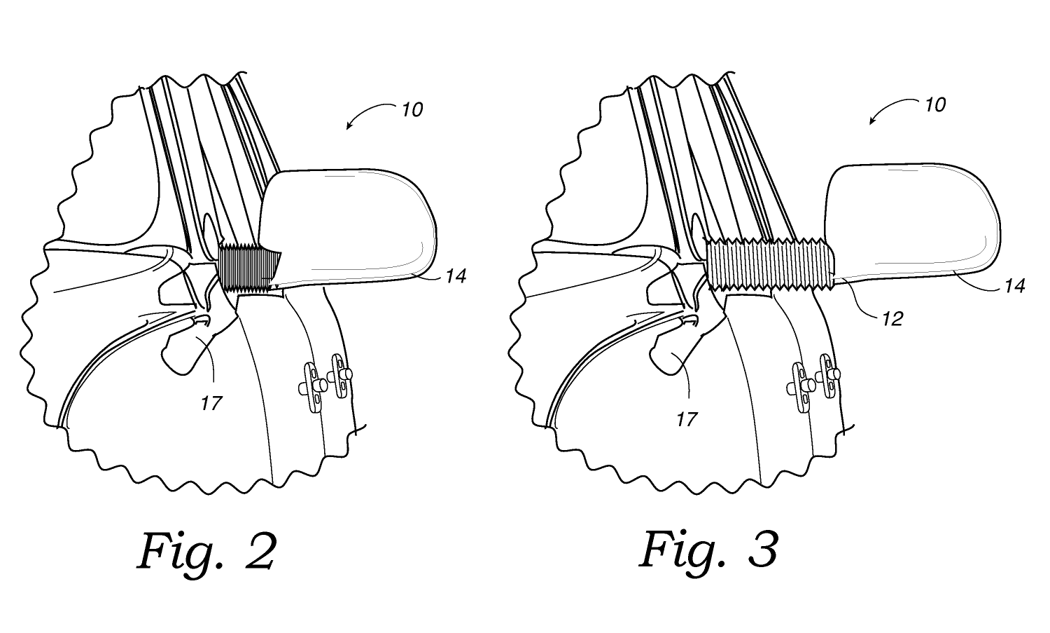

As shown in FIGS. 2 and 3, in accordance with one aspect of the invention, the mirror assembly 10 comprises a body 14 for holding a rear view mirror, an extendable telescopic arm 12, and a connector assembly 17 for attaching the telescopic arm to a vehicle.

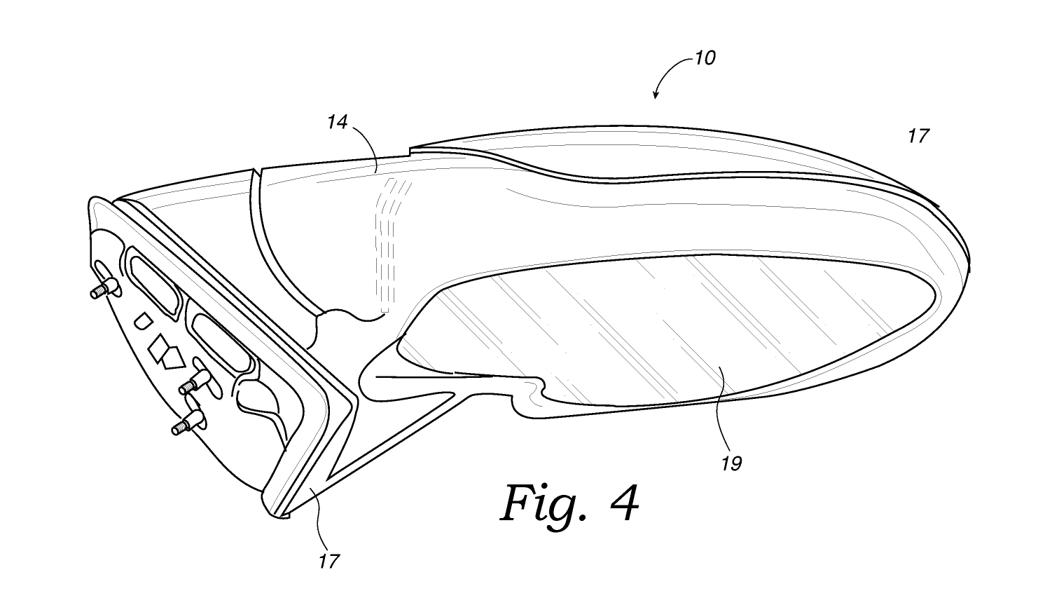

As shown in FIG. 4, the mirror 19 may be constructed from any suitable reflective material and configured to fit inside the body 14. The exterior surface of the body 14 may have an aerodynamic design and preferably match the OEM mirror designed for a specific vehicle. Certain embodiments comprise the mechanisms for fixing the position of the mirror in a desirable direction as manipulated by a driver.

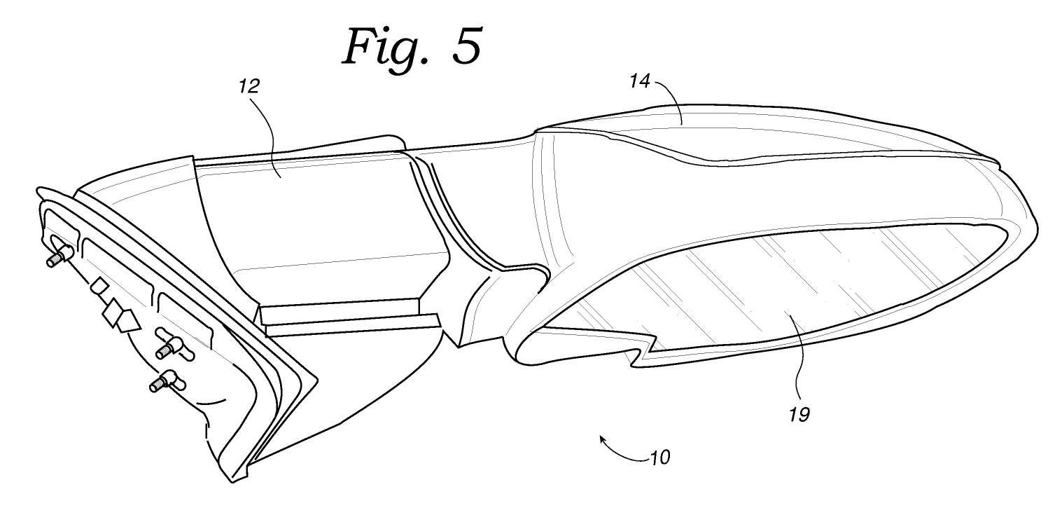

Referring to FIG. 5, a telescopic arm 12 in one end is configured to attach to the mirror body 14. On the opposite end, the telescopic arm 12 engages the connector assembly 17 for attaching the mirror body 14 to the vehicle. As provided in further detail below, the telescopic arm 12 can be extended in multiple positions in comparison to its initial position. In one embodiment, in the initial position, the telescopic arm 12 and the mirror assembly combination are identical or substantially similar to an OEM mirror designed for a particular vehicle, so that an observer cannot distinguish the extendible mirror assembly from a non-extendable OEM mirror.

The telescopic arm 12 may be designed and configured to extend and collapse manually by application of pressure, or alternatively automatically by way of an electromechanical engine. In one embodiment, the telescopic arm 12 may have several locking levels (e.g., a multi lock-step mechanism) so that a driver can control the degree with which the mirror 19 may collapse or extend, respectively toward or away from the vehicle.

In the exemplary embodiments disclosed in FIGS. 1-6, the telescopic arm 12 has, for example, two lockable extension levels such that the mirror 19 can be extended and locked in first and second extended positions. Thus, in the first extended position, the mirror 19 is locked at a first distance away from the body of the vehicle and in the second extended position the mirror 19 is locked at a second distance away from the body of the vehicle. Preferably, in the second extended position, the mirror 19 is locked at a distance further than that in the first extended position.

In an exemplary embodiment, in the first extended position, the mirror 19 may be locked at approximately three inches away, and in the second extended position the mirror 19 may be locked at approximately six inches away from the original (i.e., ground zero) position of the mirror 19. Depending on implementation the extension distance may be modified or adjusted for various embodiments of the invention or different vehicle makes and models in which the mirror 19 is used.

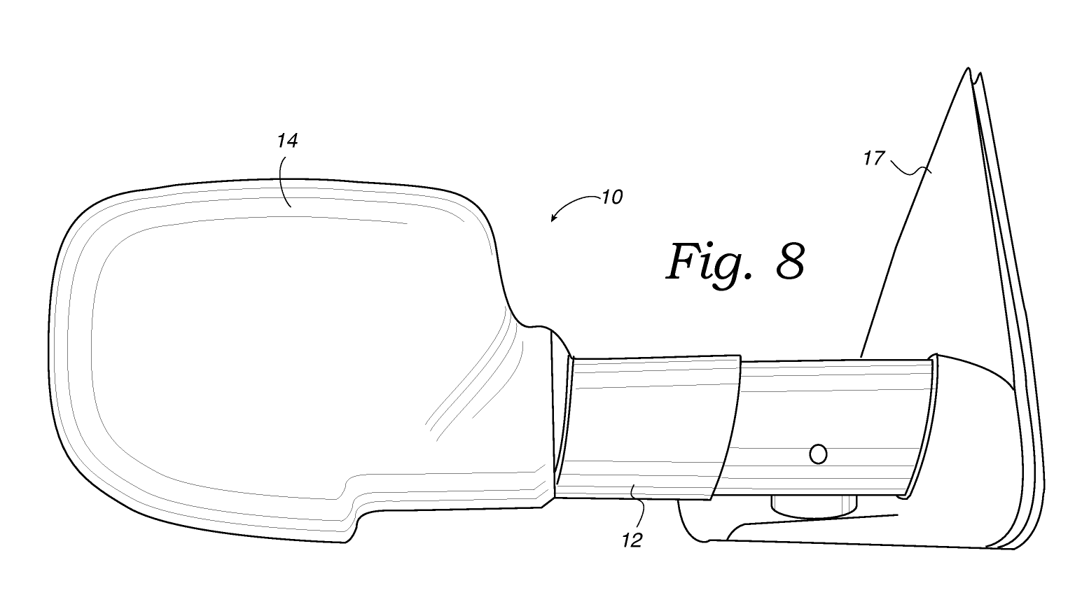

The functional and structural design of the telescopic arm 12 can vary depending on implementation and may be modified to include a non-locking-extendable mechanism (e.g., co-axial inter-sliding cylinders) to allow the telescopic arm 12 to extend and collapse without locking into predetermined positions. See FIG. 8. In an exemplary embodiment disclosed in FIGS. 2 and 3, the telescopic arm may be encapsulated in a corrugated cover for a different aesthetic appearance, for example.

It is appreciated that regardless of the disclosed exemplary structures for the telescopic arm 12, other embodiments of the invention may be contemplated that would perform the same function without incorporating the specific structural features provided here. That is, the scope of the invention is intended and should be construed to cover other functional and structural embodiments that would allow the mirror body 14 to be extended and retracted in one or more positions with respect to the connector assembly 17.

Alternative extendable and retractable mechanisms that may be used include but are not limited to the following, whether alone or in combination with other mechanisms: foldable, creased or hinged mechanisms, accordion-like mechanisms, snap-fit mechanisms, wheel and rope/belt mechanisms, interlocking gear mechanisms, sliding lock-step mechanisms, interlocking collapsible mechanisms, and free sliding collapsible mechanisms.

Referring to FIGS. 4-8, a preferred embodiment of the invention is disclosed in further detail below. FIG. 4 illustrates the mirror assembly 10 in a ground zero position, wherein the mirror 19 is locked at a distance relatively closest to the connector assembly 17. The connector assembly 17 is the portion of the mirror assembly 10 that is directly connected to the body of the vehicle. As shown, the telescopic arm 12 of the mirror assembly 10 is preferably not visible when the mirror 19 is in the ground zero position. Thus advantageously, when the mirror 19 is in ground zero position the aesthetic look and feel of the mirror 19 substantially resembles the look and feel of a non-extendible (e.g., OEM) mirror assembly.

FIG. 5 illustrates an embodiment of the mirror assembly 10 in a first extended position. In this position, the mirror assembly 10 is extended away from the body of the vehicle and locked in a first position. As shown, a first portion of the telescopic arm 12 is visible in the first locked position. Preferably, the first portion of the telescopic arm 12 slides in relationship to a second portion of the telescopic arm (not shown in FIG. 5) to allow the mirror 19 to move toward or away from the connector assembly 17.

In one embodiment, a first snap-fit mechanism is designed to lock the first portion of the telescopic arm to the second portion of the telescopic arm in first and second positions, for example. In one embodiment, a spring-loaded hook can be formed on, for example, the internal surface of the first telescopic arm so that the hook removably engages a first cavity or perforation formed on the external surface of the second telescopic arm for receiving the hook. When the hook is caught in the first cavity, the first portion of the telescopic arm is locked into the second portion.

In response to external pressure applied to the mirror beyond a first threshold, the spring-loaded hook can be disengaged from the first cavity. Preferably, the spring-loaded hook is designed such that application of pressure within a certain threshold does not damage the physical structure of the hook or the cavity, so that the locking mechanism is durable. In other embodiments, a quick release button or other pressure or touch actuated mechanism can be used to control the locking and unlocking function.

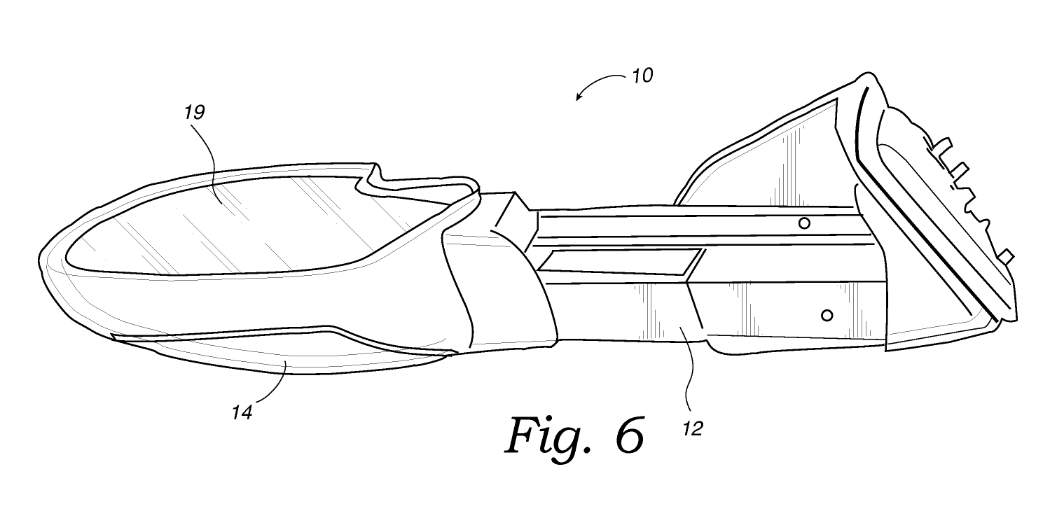

Depending on the direction in which the pressure is applied (e.g., toward or away from the connector assembly) the first portion of the telescopic arm will either move (i.e., collapse) toward the ground zero position shown in FIG. 4, or move (i.e., extend) toward a fully extended position shown in FIG. 6.

In the fully extended position, the spring-loaded hook may engage a second corresponding cavity or perforation formed on the external surface of the second portion of the telescopic arm, so that the first portion of the telescopic arm is locked in a second position Application of pressure beyond a certain threshold can cause the hook to disengage from the corresponding cavity so that the first portion of the telescopic arm can slide back toward the first or the ground zero positions.

It is noteworthy that the position of the spring-loaded hook and the receiving cavity can be modified depending on implementation, so that the hook is formed on the second portion of the telescopic arm, and the cavity is formed on the first portion of the telescopic arm without detracting from the scope of the invention. As noted earlier, the snap-fit mechanism disclosed here by way of example is one of many exemplary locking mechanisms that can be used to achieve the purpose of the invention. As such, the scope of the invention should not be construed as limited to the specific exemplary embodiments disclosed herein.

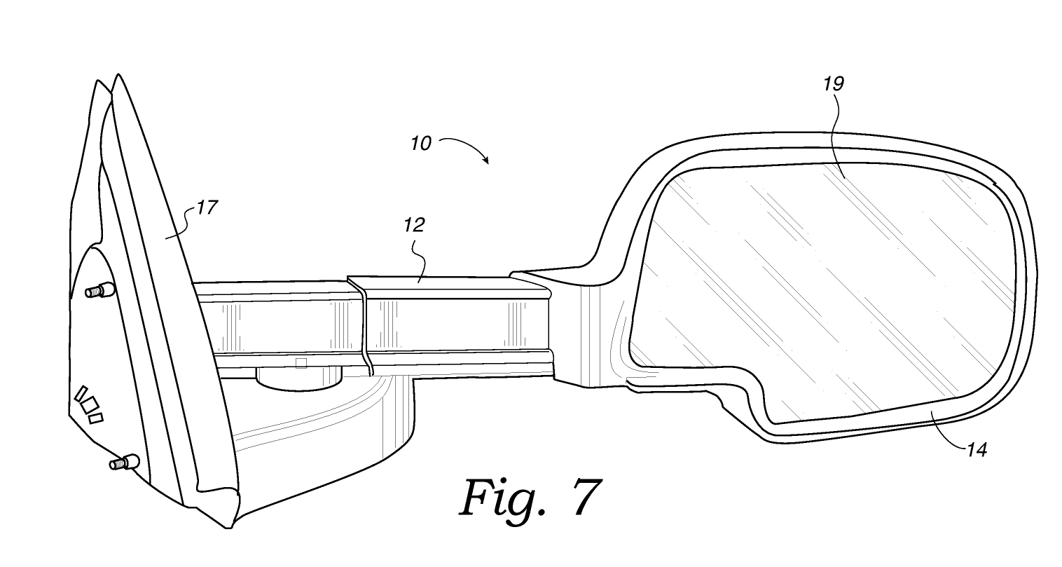

FIG. 7 illustrates a front elevation view of a side view mirror in a fully extended position, in accordance with one embodiment. FIG. 8 illustrates a rear elevation view of a side view mirror, in accordance with another embodiment.

The invention has been described with reference to one or more embodiments. It is evident that other alternatives, modifications, variations and embodiments may be apparent to those skilled in the art in light of the foregoing description. Thus, it should be understood that the invention is not limited by the foregoing descriptions of the preferred embodiments, but embraces all alternatives, modifications, and variations in accordance with the spirit and scope of the appended claims and their full scope of equivalents.

1. An extendable mirror assembly comprising:
a mirror body configured to hold a mirror;
an extendable arm having opposing first and second terminal ends, wherein the mirror body is coupled to the first terminal end; and
a connector assembly coupled to the second terminal end, the connector assembly configured for attachment to body of a vehicle,
wherein the mirror body may be moved toward and away from the connector assembly by way of the extendible arm when force is applied in first and second directions to the mirror body, and wherein the extendable arm respectively collapses and extends in response to the application of force.

2. The assembly of claim 1, wherein the extendable arm is locked in at least one position as the mirror body moves in relation to the connector assembly.

3. The assembly of claim 1, wherein the extendable arm comprises:
a first portion comprising a first elongated arm; and
a second portion comprising a second elongated arm in a sliding relationship with the first elongated arm,
such that the first portion engages the second portion in first and second locking positions when the first and second portions slide in relation to one another.

4. The assembly of claim 3, wherein in the first and the second locking positions, the first portion disengages from the second portion in response to application of force beyond a predetermined threshold.

5. The assembly of claim 3, wherein the first portion comprises a spring-loaded hook for engaging a cavity formed on the second portion.

6. The assembly of claim 5, wherein when the spring-loaded hook engages the cavity, the first portion is locked to the second portion such that the extendable arm can no longer extend or collapse.

7. The assembly of claim 5, wherein when the spring-loaded hook disengages from the cavity, the first portion is unlocked from the second portion such that the extendable arm can continue to extend or collapse.

8. The assembly of claim 5, wherein in the first locking position the mirror body is a first distance away from the connector assembly.

9. The assembly of claim 8, wherein in the second locking position the mirror body is a second distance away from the connector assembly.

10. The assembly of claim 9, wherein the second distance is larger than the first distance.
